(19) United States
(12) Patent Application Publication
(10) Pub. No.: US 2016/0239131 A1
(43) Pub. Date: Aug. 18, 2016

(54) CIRCULAR TOUCH PANEL AND MANUFACTURING METHOD OF THE SAME

(71) Applicant: Samsung Display Co., Ltd., Yongin-city (KR)

(72) Inventor: Sung Ku Kang, Suwon-si (KR)

(21) Appl. No.: 14/807,206

(22) Filed: Jul. 23, 2015

(30) Foreign Application Priority Data
Feb. 16, 2015 (KR) 10-2015-0023359

(51) Int. Cl. G06F 3/041

(52) U.S. Cl. CPC G06F 3/0412; G06F 2203/04103

(57) ABSTRACT

A circular touch panel disposed on a circular display panel including a plurality of pixels, the circular touch panel including: a plurality of sensing electrodes; a plurality of connection wirings connecting the plurality of sensing electrodes to a signal processing circuit; and an insulator insulating the plurality of sensing electrodes from each other. The circular touch panel includes a circular boundary region patterned in an optical pattern.

### CROSS-REFERENCE TO RELATED APPLICATION

This application claims priority from and the benefit of Korean Patent Application No. 10-2015-0023359, filed on Feb. 16, 2015, which is hereby incorporated by reference for all purposes as if fully set forth herein.

### BACKGROUND

1. Field

Exemplary embodiments relate to a circular touch panel and a manufacturing method of the same, and more particularly, to a circular touch panel configuring a circular display device and a manufacturing method of the same.

2. Discussion of the Background

In accordance with the development of wearable smart devices, e.g., smart watches, or the like, there has been an increased demand for circular display devices. As representative examples, a smart watch, smart glasses, or the like, which include a circular display panel, have been developed. The circular display device may be configured by employing a structure of a general quadrangular display device. A display panel of the general quadrangular display device includes a plurality of pixels disposed in a row and column form and displays an image to a user by transferring light emitted from the plurality of pixels. In this case, the pixels are generally configured in a quadrangular shape. When a circular display device is configured with quadrangular pixels, the plurality of quadrangular pixels are disposed in a step shape or sawtooth shape in order to configure a circular boundary region of the circular display device. Therefore, there is a problem that a user may observe an image which is not smooth at the circular boundary region.

The above information disclosed in this Background section is only for enhancement of understanding of the background of the inventive concept, and, therefore, it may contain information that does not form the prior art that is already known to a person of ordinary skill in the art.

### SUMMARY

Exemplary embodiments relate to a circular touch panel and a manufacturing method of the same.

Additional features of the invention will be set forth in the description which follows, and in part will be apparent from the description, or may be learned by practice of the invention.

An exemplary embodiment discloses a circular touch panel disposed on a circular display panel including a plurality of pixels, the circular touch panel including: a plurality of sensing electrodes; a plurality of connection wirings connecting the plurality of sensing electrodes to a signal processing circuit; and an insulator insulating the plurality of sensing electrodes from each other. The circular touch panel includes a circular boundary region patterned in an optical pattern.

An exemplary embodiment discloses a manufacturing method of a circular touch panel, the manufacturing method including: forming a plurality of connection wirings by depositing and patterning a first metal layer on an insulating substrate; forming a plurality of sensing electrodes by depositing and patterning a second metal layer such that sensing electrodes disposed adjacent to the plurality of connection wirings are connected to the plurality of connection wirings, respectively; and forming and patterning an insulator so as to insulate the plurality of sensing electrodes. When at least one of the plurality of connection wirings, the plurality of sensing electrodes, and the insulator is patterned, an optical pattern is simultaneously patterned on a circular boundary region of the circular touch panel.

An exemplary embodiment also discloses a touch screen panel, including: a substrate including a curved boundary region; a plurality of sensing electrodes disposed on the substrate; a connection wiring connecting one of the plurality of sensing electrodes to a signal processing circuit; and an insulator disposed on the plurality of sensing electrodes. An optical pattern is disposed on the curved boundary region to change a light propagation direction.

An exemplary embodiment provides advantages capable of providing a smooth image to a user by creating an optical effect at a circular boundary region.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a drawing showing a stacked structure of a circular display device according to an exemplary embodiment.

FIG. 2 is a diagram illustrating a corresponding relationship between a circular display panel and a circular touch panel according to an exemplary embodiment.

FIG. 3A and FIG. 3B are diagrams showing shapes in which an insulator of a circular boundary region of the circular touch panel is patterned in an optical pattern of a multiple-slit pattern according to an exemplary embodiment.

FIG. 4A and FIG. 4B are diagrams showing shapes in which an insulator of a circular boundary region of a circular touch panel is patterned in an optical pattern of a mesh pattern according to an exemplary embodiment.

FIG. 5A and FIG. 5B are diagrams showing shapes in which a first metal layer of a circular boundary region of a circular touch panel is patterned in an optical pattern of a multiple-slit pattern according to an exemplary embodiment.

FIG. 6A and FIG. 6B are diagrams showing shapes in which a second metal layer of a circular boundary region of a circular touch panel is patterned in an optical pattern of a multiple-slit pattern according to an exemplary embodiment.

FIG. 7A, FIG, 7B, and FIG. 7C are diagrams illustrating a manufacturing method of a circular touch panel of FIG. 3 according to an exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

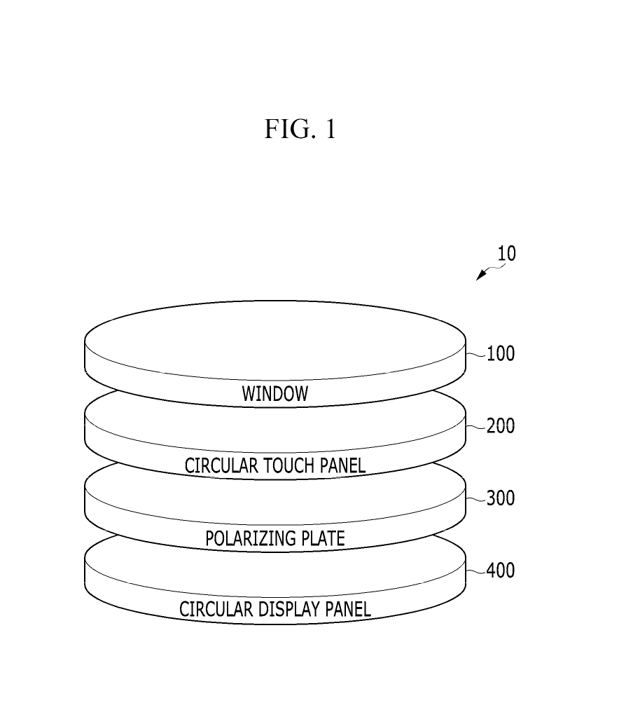

FIG. 1 is a drawing showing a stacked structure of a circular display device according to an exemplary embodiment.

Referring to FIG. 1, a circular display device 10 is configured in a stacked structure including a window 100, a circular touch panel 200, a polarizing plate 300, and a circular display panel 400.

Although the above exemplary embodiment shows a configuration in which the circular touch panel 200 and the circular display panel 400 are separately formed, the circular touch panel 200 and the circular display panel 400 may be integrally formed based on an on-cell scheme, an in-cell scheme, or the like in various configurations.

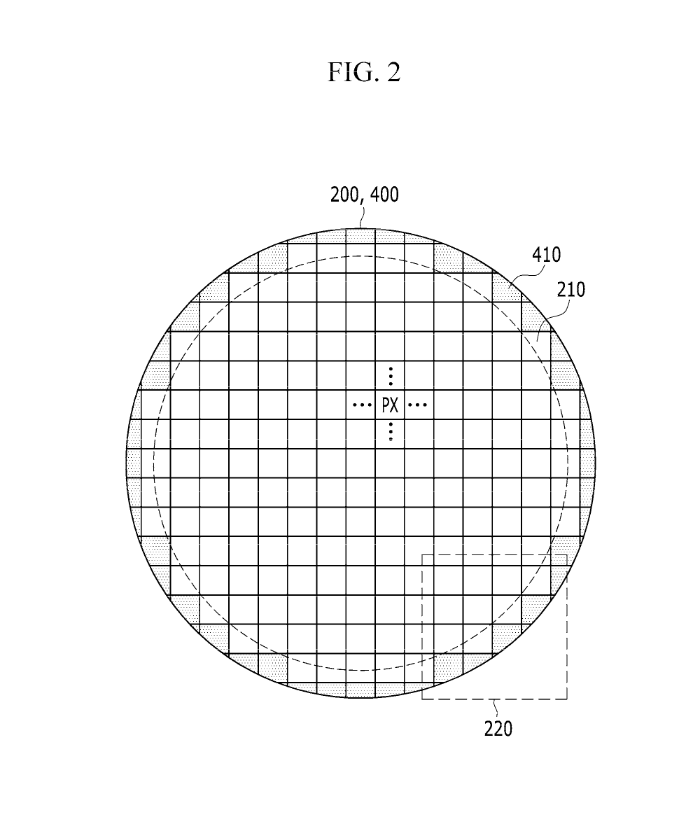

The circular display panel 400 includes a plurality of pixels PX (see FIG. 2) and the plurality of pixels emit light according to a grayscale of an input image. The light may be provided from a backlight unit and passes through the pixels PX. Further, an organic light emitting diode or other display panel structures may be configured in the circular display panel 400. The plurality of pixels PX, each of which may be configured in a quadrangular shape, may be arranged in approximately a matrix form including rows and columns of pixels. A detailed description thereof will be provided with reference to FIG. 2.

As noted above, the circular display panel 400 may be an organic light emitting display panel including a plurality of organic light emitting diodes (OLED) and a liquid crystal display panel having an interposed liquid crystal layer. One or more exemplary embodiments will be described in relation to characteristics of the circular touch panel 200 and a kind of circular display panel 400 is not limited to the examples illustrated herein.

The window 100 may be formed of glass, synthesized resin, or the like for protecting the circular display device 10 and may be attached by interposing an adhesive layer (not shown).

Although FIG. 1 illustrates a case in which the circular touch panel 200 is attached to the window 100 while being disposed close to the window 100, positions of the polarizing plate 300 and the circular touch panel 200 may be exchanged with each other, and a configuration of the polarizing plate 300 may be omitted depending on a kind of display device.

The polarizing plate 300 shown in FIG. 1 may be a circular polarizing plate, and in this case, the circular display panel 400 may be an organic light emitting display panel. More specifically, the organic light emitting display device generally includes a polarizer such as the circular polarizing plate, or the like, in order to prevent a decrease of a contrast ratio by an external light reflection.

However, in a case in which the circular display panel 400 is the liquid crystal display panel, linear polarizing plates having a polarizing axis of 90° may be disposed over and below the circular display panel 400, respectively. The kind and the number of polarizing plates described above may be changed depending on a mode of the liquid crystal display panel. For example, a first linear polarizing plate may be disposed beneath the circular display panel 400 and a second linear polarizing plate may be disposed above the circular display panel 400. Another layer may be configured between the circular display panel 400 and one of the first linear polarizing plate and the second linear polarizing plate. The transmission axis of the first linear polarizing plate and the transmission axis of the second linear polarizing plate may be perpendicular to each other so that the two axes form 90°. However, the degree formed by the two axes may be configured differently according to various configurations.

Therefore, the kind, the position, and the polarization types, and the number of polarizing plates 300 are not limited as such.

FIG. 2 is a diagram illustrating a corresponding relationship between a circular display panel and a circular touch panel according to an exemplary embodiment.

Referring to FIG. 2, the circular display panel 400 and the circular touch panel 200 are configured so as to be overlapped with each other. FIG. 2 shows a case in which the outer circular boundary of the circular display panel 400 and the outer circular boundary of the circular touch panel 200 are matched to each other, but it is apparent to those skilled in the art that sizes of the outer circular boundaries of the circular display panel 400 and the circular touch panel 200 may be changed depending on a product design. For example, the outer circular boundary of the circular display panel 400 may also be larger or smaller than the outer circular boundary of the circular touch panel 200. In such a configuration, the center of the circular display panel 400 and the center of the circular touch panel 200 may be configured to be overlapped.

According to the illustrated exemplary embodiment, the circular display panel 400 includes a plurality of quadrangular pixels PX. Although the quadrangular shape is illustrated as a general shape of a pixel PX, the plurality of pixels PX may be arranged regularly with each other while having a certain shape such as a pentagon, a hexagon, or the like.

In order to configure the circular display panel 400 by arranging the plurality of quadrangular pixels PX, a step shape or sawtooth shape appears at the outer circular boundary region 210, 410 as shown in FIG. 2.

The lower the resolution, the less smooth an image will appear to a user in the circular boundary region 210 for boundary pixels having a step shape, a saw-tooth shape, and the like.

To address such a problem, the circular boundary region 210 may be covered by a black matrix or other elements, but there is another problem that the size of a display area decreases and the thickness of the surrounding bezel needs to be thicker.

To address such problems, exemplary embodiments disclose a method of patterning the circular boundary region 210 by a predetermined optical pattern, in order to provide a smooth image display to the eyes of users while maintaining the size of the display area and a narrow bezel configuration.

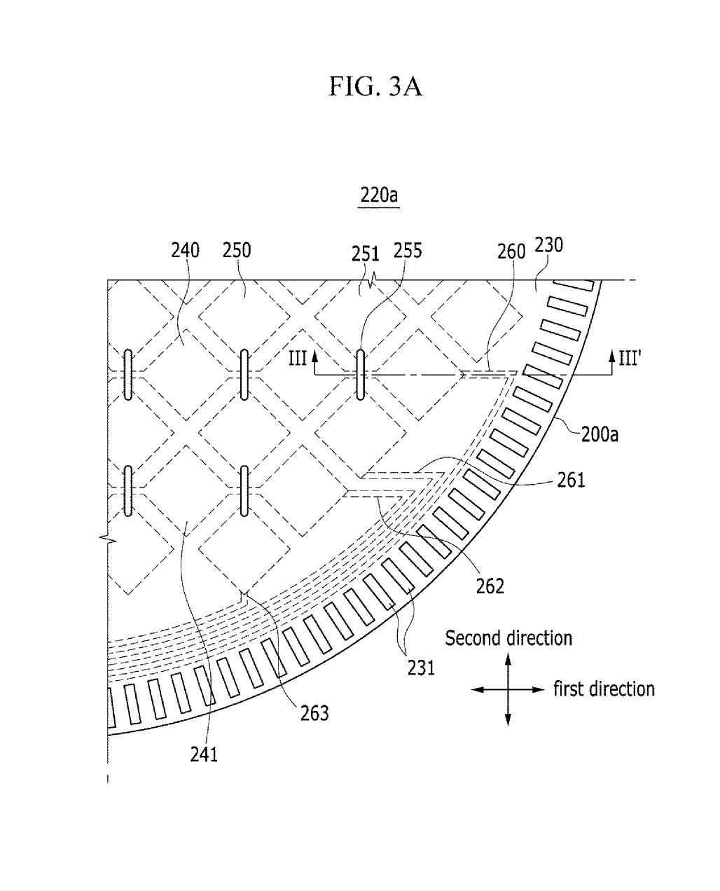

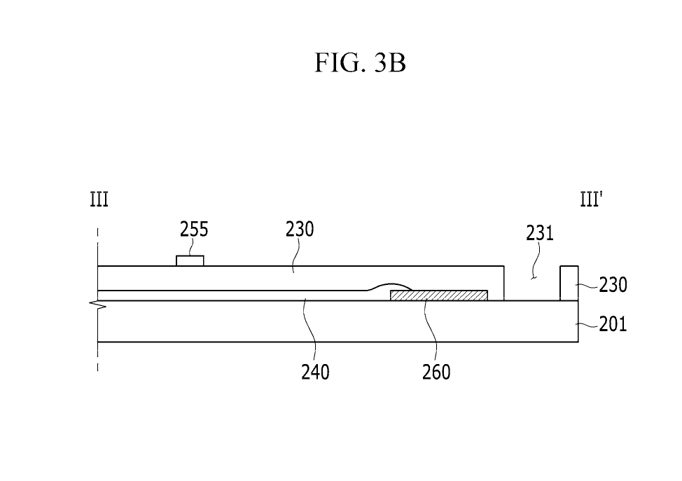

Hereinafter, enlarged portions 220a, 220b, 220c, and 220d included in the portion 220 of the circular touch panel 200 will be described with reference to FIGS. 3A to 7C. Such configurations may also be applicable to other portions of the circular boundary region 210, 410.

FIG. 3A and FIG. 3B are diagrams showing shapes in which an insulator of a circular boundary region of a circular touch panel is patterned in an optical pattern of a multiple-slit pattern according to an exemplary embodiment.

Referring to FIG. 2, FIG. 3A, and FIG. 3B, the circular touch panel 200 includes a plurality of connection wirings 260, 261, 262, and 263, a plurality of first sensing electrodes 240 and 241, a plurality of second sensing electrodes 250 and 251, an insulator 230, and a plurality of bridge electrodes 255, which may be stacked on an insulating substrate 201.

The stacked structure of the connection wirings, the sensing electrodes, the insulator, and the bridge electrodes shown in the exemplary embodiment may be changed while the electrical connection relationship thereof is maintained, and the exemplary embodiment shows the stacked structure and the connection relationship as an example.

The plurality of first sensing electrodes 240 and 241 may be each formed to extend in a first direction and the plurality of second sensing electrodes 250 and 251 may be each formed to extend in a second direction which is perpendicular to the first direction.

According to an exemplary embodiment, the circular touch panel 200 is shown as a mutual-capacitance type in which the first sensing electrodes 240 and 241 and the second sensing electrodes 250 and 251 form mutual-capacitances.

However, even if the circular touch panel 200 is the mutual-capacitance type, the circular touch panel 200 may have a form in which the first sensing electrodes 240 and 241 and the second sensing electrodes 250 and 251 face each other because the first sensing electrodes 240 and 241 and the second sensing electrodes 250 and 251 are formed on different layers, not the same layer, and the circular touch panel 200 may be configured as a self-capacitance type because the first sensing electrodes 240 and 241 and the second sensing electrodes 250 and 251 may be formed on the same layer or different layers.

The mutual-capacitance type illustrated in an exemplary embodiment is merely one exemplary embodiment and does not limit the scope of the present invention.

The plurality of first sensing electrodes 240 and 241 and the plurality of second sensing electrodes 250 and 251 may be formed of or include a transparent electrode, such as indium tin oxide (ITO), and may be formed in a mesh shape. In the case in which the first sensing electrodes 240 and 241 and the second sensing electrodes 250 and 251 are formed in the mesh shape, the first sensing electrodes 240 and 241 and the second sensing electrodes 250 and 251 may be configured to include an opaque metal. In an exemplary embodiment, the material configuring the plurality of first sensing electrodes 240 and 241 and the plurality of second sensing electrodes 250 and 251 may be referred to as a second metal layer.

The plurality of connection wirings 260, 262, 263, and 261 may be disposed at an outer portion of the insulating substrate 201 and electrically connect the plurality of first sensing electrodes 240 and 241 and the plurality of second sensing electrodes 250 and 251 to a signal processing circuit (not shown) configured to process a touch signal, respectively. For example, if a user touches the circular touch panel 200, the signal processing circuit may recognize the touch and generate a touch signal.

The plurality of connection wirings 260, 261, 262, and 263 may be disposed to surround an outer portion of the circular touch panel 200 as shown in FIG. 3A. Accordingly, since the plurality of connection wirings 260, 261, 262, and 263 are formed so as not to be overlapped with the display area, the plurality of connection wirings 260, 261, 262, and 263 may be configured of an opaque low resistance metal. The plurality of connection wirings 260, 261, 262, and 263 may be configured of a single or composite material, such as silver (Ag), copper (Cu), chromium (Cr), aluminum (Al), molybdenum/aluminum/molybdenum (Mo/Al/Mo), or the like. In various configurations, the plurality of connection wirings 260, 261, 262, and 263 may include a transparent material. In an exemplary embodiment, the material configuring the plurality of connection wirings 260, 261, 262, and 263 may be referred to as a first metal layer if the connection wirings 260, 261, 262, and 263 include a single or composite material, such as silver (Ag), copper (Cu), chromium (Cr), aluminum (Al), molybdenum/aluminum/molybdenum (Mo/Al/Mo), or the like, or a metal other than the materials listed above.

The plurality of first sensing electrodes 240 and 241 may be each formed to be integrally extended in the first direction. In the case in which the plurality of second sensing electrodes 250 and 251 are formed on the same layer as that of the plurality of first sensing electrodes 240 and 241, the plurality of second sensing electrodes 250 and 251 may be formed in an island-type for insulation with the plurality of first sensing electrodes 240 and 241.

Therefore, in order for each of the plurality of second sensing electrodes 250 and 251 to extend in the second direction, the bridge electrode 255 may be used to connect the isolated second sensing electrodes 250 and 251. In order to prevent the bridge electrode 255 and the first sensing electrodes 240 and 241 from being electrically connected to each other, the insulator 230 may be interposed therebetween.

The insulator 230 may be patterned to have a via-hole so that the bridge electrode 255 connects adjacent two of the second sensing electrodes of the island-type to each other. However, the insulator 230 itself may be patterned in the island-type depending on a kind of circular touch panel 200, and this may be changed depending on different product configurations.

Both in the case in which the insulator 230 is patterned in the island-type and in the case in which the insulator 230 is patterned to have the via-hole, at least one patterning process may need to be performed.

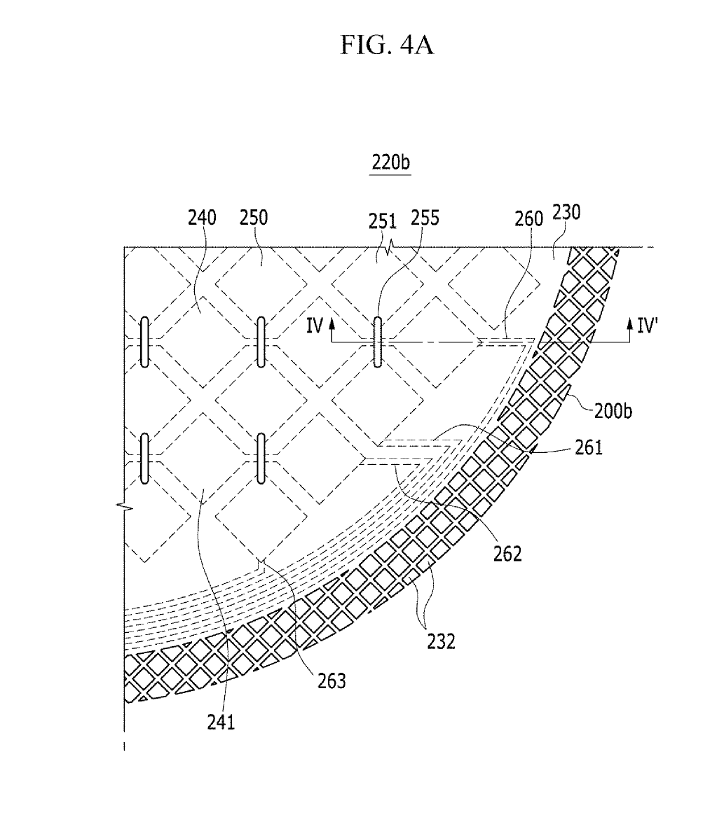

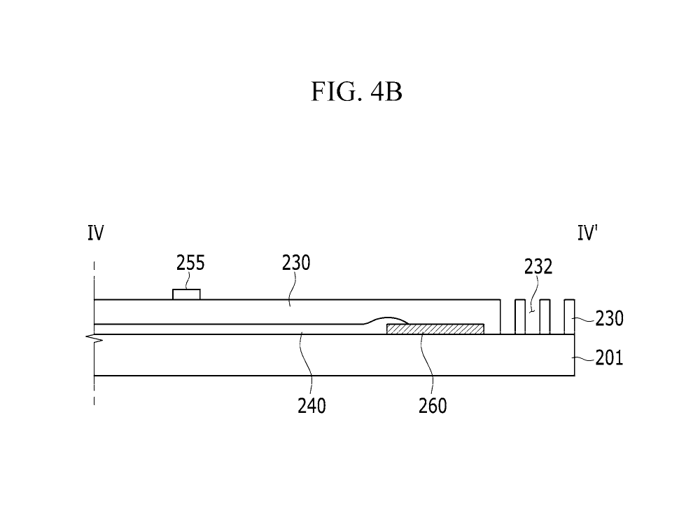

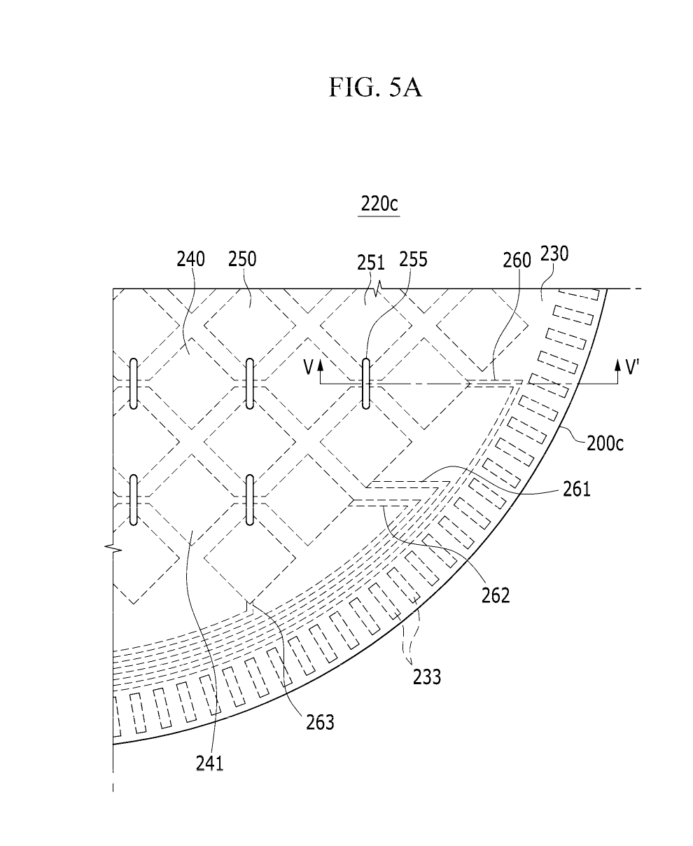

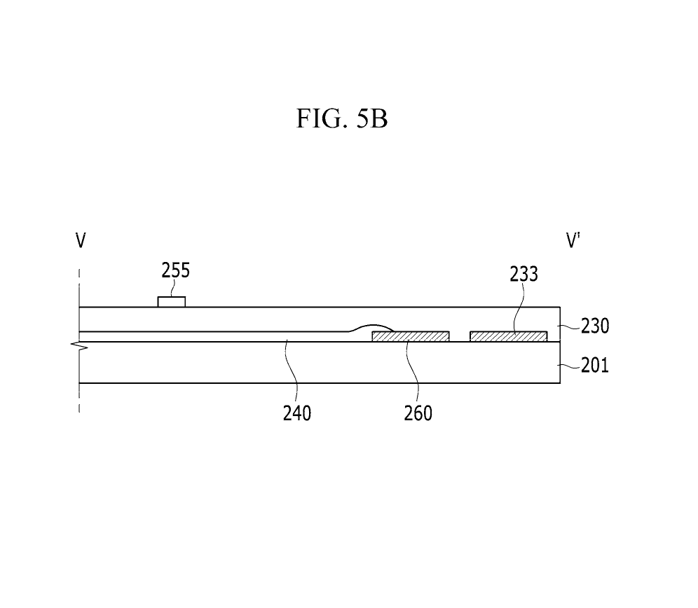

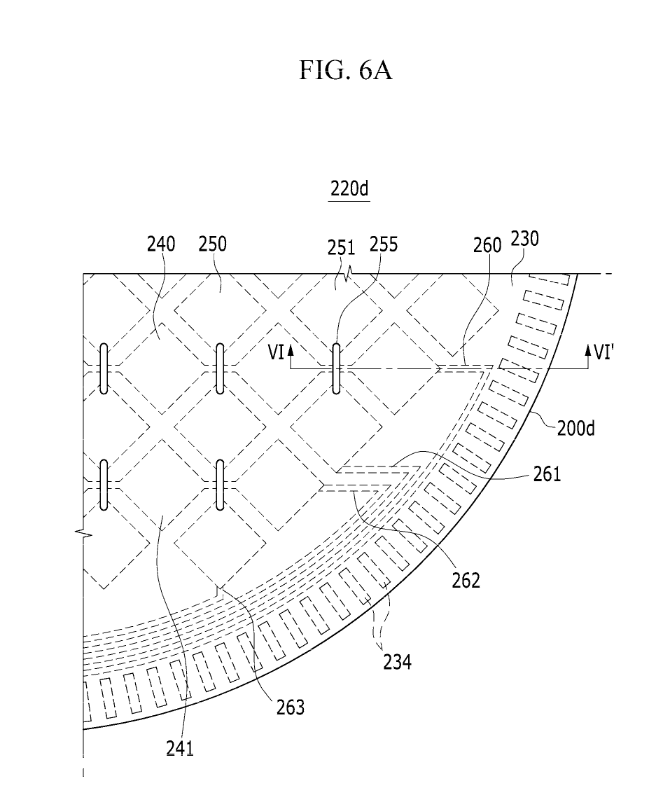

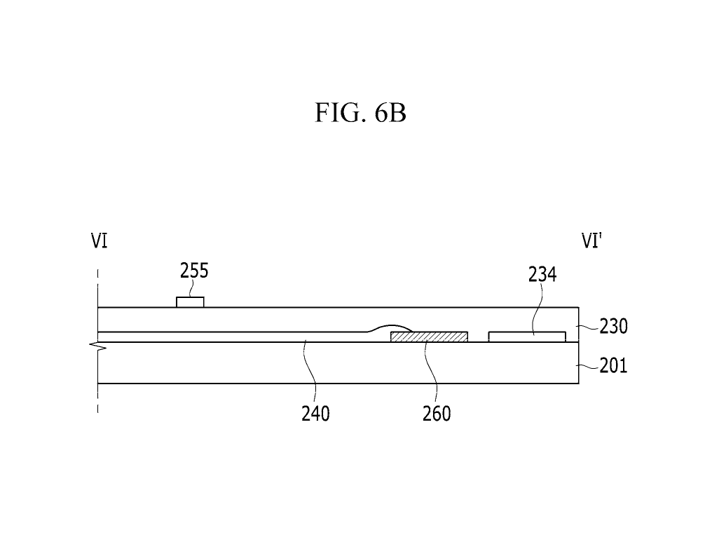

According to the illustrated exemplary embodiment, an optical pattern may be patterned together on the circular boundary region 210 during the patterning process. Therefore, an optical effect may be obtained without adding a separate material deposition process or a separate patterning process. Further, the optical pattern in the circular boundary region 210 may include a material substantially identical to a material used for forming at least one of the plurality of the insulator 230, and the plurality of connection wirings 260, 261, 262, and 263, and sensing electrodes 240 (see e.g., FIG. 4B, FIG. 5B, and FIG. 6B, respectively).

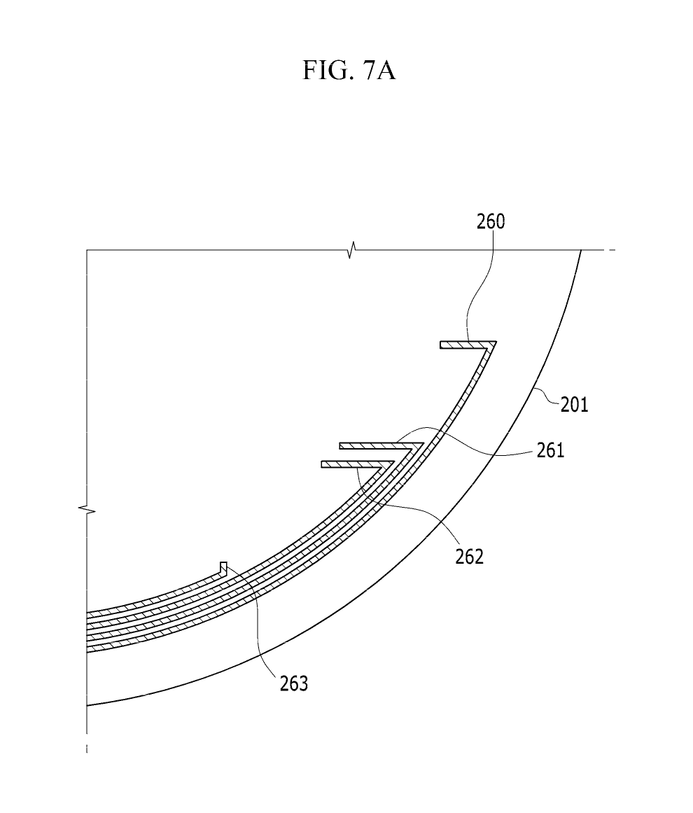

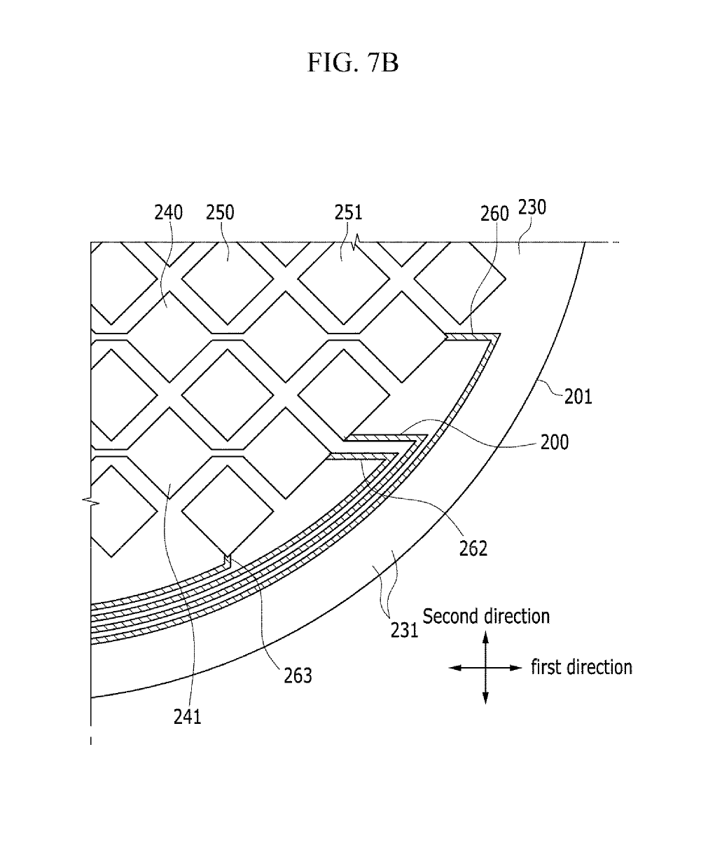

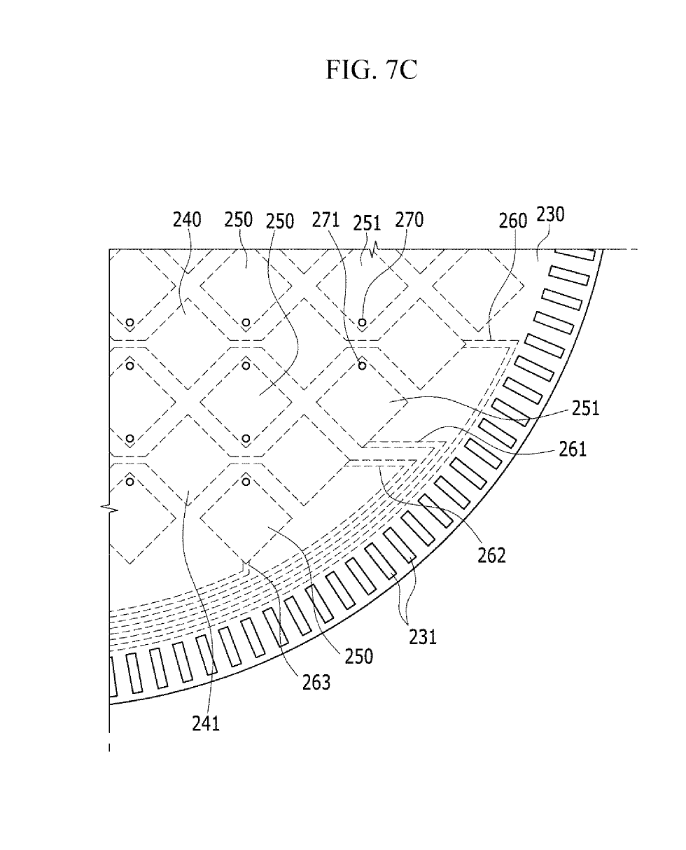

A manufacturing method of a circular touch panel 200a will be described in more detail with reference to FIG. 7A to FIG. 7C.

The optical pattern is a pattern that changes the direction of light propagation, e.g., a pattern exhibiting at least one optical effect of a light diffraction effect, a light interference effect, and a light scattering effect. The above-mentioned optical effects help a user to observe a smoother image by smoothly alleviating a boundary of the step shape of the circular display panel 400.

The optical effect generated according to an exemplary embodiment is satisfied as long as it has an effect of alleviating the boundary of the step shape of the circular display panel 400, and is not limited by the name of the effect, such as the diffraction effect, or the like.

The optical pattern according to an exemplary embodiment may be configured of at least one pattern of a multiple-slit pattern, a mesh pattern, and an irregular pattern. The optical pattern is satisfied as long as it shows the optical effects described above, and the listed patterns are merely examples of available optical patterns to generate such an optical effect.

The optical pattern shown in FIG. 3A and FIG. 3B is a multiple-slit pattern 231. In the multiple-slit pattern 231, a material of the insulator 230 and an opening may be repeatedly arranged with a predetermined size. In this case, the slit pattern may have an interval of several micrometers. The circular boundary region 210 may include a non-emitting region in which pixels are not disposed. In the non-emitting region, multiple-slit pattern 231 may be disposed to change a light propagation direction so that a user may see an optical effect, such as a light diffraction effect, a light interference effect, and a light scattering effect, from the non-emitting region. Further, the multiple-slit pattern 231 may have different pattern, such as multiple recesses or indentations to produce an optical pattern, such as a light diffraction effect, a light interference effect, and a light scattering effect.

A repeat interval of the slit pattern may have a size changed depending on the optical effect to be shown, and the slit pattern may also be repeated at an irregular size and may also be changed while having a sequential change.

The insulator 230 may be configured to be transparent, but since the insulator 230 has a reflective index different from that of air, the insulator 230 may be patterned so as to have the optical effect to be implemented.

FIG. 4A and FIG. 4B are diagrams showing shapes in which an insulator of a circular boundary region of a circular touch panel is patterned in an optical pattern of a mesh pattern according to an exemplary embodiment.

Unlike FIG. 3A and FIG. 3B, FIG. 4A and FIG. 4B disclose an exemplary embodiment in which the optical pattern of the circular boundary region 210 is configured of a mesh pattern 232.

The mesh pattern 232 shown in FIG. 4A and FIG. 4B has diamond-shaped opening parts arranged with a predetermined interval. However, this shape is merely one exemplary embodiment. Thus, according to different configurations, a triangular, pentagonal, hexagonal, or random mesh pattern may be configured.

FIG. 5A and FIG. 5B are diagrams showing shapes in which a first metal layer of a circular boundary region of a circular touch panel is patterned in an optical pattern of a multiple-slit pattern according to an exemplary embodiment.

Referring to FIG. 5A and FIG. 5B, the first metal layer is patterned to configure an optical pattern instead of the insulator 230 illustrated in FIG. 3A and FIG. 3B. The optical pattern illustrated in FIG. 5A and FIG. 5B is a multiple-slit pattern 233. However, other patterns, e.g., the mesh pattern illustrated in FIG. 4A, may be employed in configuring the first metal layer.

The multiple-slit pattern 231 shown in FIG. 3A and FIG. 3B is the optical pattern formed by performing the patterning together with the insulator 230 when the insulator 230 is patterned, but the multiple-slit pattern 233 shown in FIG. 5A and FIG. 5B is formed by patterning the first metal layer together with the plurality of connection wirings 260, 261, 262, and 263 when the plurality of connection wirings 260, 261, 262, and 263 are patterned, by depositing the first metal layer on the insulating substrate 201.

Similar to the structure shown in FIG. 3A and FIG. 3B, an optical effect may be obtained without adding a separate material deposition process or a separate patterning process.

Although the first metal layer is patterned in the multiple-slit pattern 233, the first metal layer may also be patterned in a mesh pattern, an irregular pattern, or the like.

In addition, both the first metal layer and the insulator 230 may be complexly patterned, thereby configuring a complex optical pattern. In this case, since the first metal layer and the insulator 230 are materials having different reflective indexes and are patterned in different patterns from each other, more diverse optical effects may be attained.

FIG. 6A and FIG. 6B are diagrams showing shapes in which a second metal layer of a circular boundary region of a circular touch panel is patterned in an optical pattern of a multiple-slit pattern according to an exemplary embodiment.

Referring to FIG. 6A and FIG. 6B, the second metal layer is patterned to configure the optical pattern instead of the insulator 230 in FIG. 3A. The optical pattern illustrated in FIG. 6A and FIG. 6B is a multiple-slit pattern 234. However, other patterns, e.g., the mesh pattern illustrated in FIG. 4A, may be employed in configuring the second metal layer. The second metal layer may be materially different from the metal layer formed by patterning the wirings 260, 261, 262, 263, and may separately formed.

The multiple-slit pattern 231 shown in FIG. 3A and FIG. 3B is the optical pattern formed by performing the patterning together with the insulator 230 when the insulator 230 is patterned, but the multiple-slit pattern 234 shown in FIG. 6A and FIG. 6B is formed by patterning the second metal layer together when the plurality of first sensing electrodes 240 and 241 and the plurality of second sensing electrodes 250 and 251 are formed, by depositing and patterning the second metal layer after the plurality of connection wirings 260, 261, 262, and 263 are patterned.

Similar to the structure shown in FIG. 3A and FIG. 3B, an optical effect may be obtained without adding a separate material deposition process or a separate patterning process.

Although the second metal layer is patterned in the multiple-slit pattern 234 in FIG. 6A and FIG. 6B, the second metal layer may also be patterned in a mesh pattern, an irregular pattern, or the like.

In addition, the second metal layer and the insulator 230 may be complexly patterned, thereby configuring a complex optical pattern. In this case, since the first metal layer and the insulator 230 are materials having different reflective indexes and are patterned in different patterns from each other, more diverse optical effects may be shown.

In addition, by configuring the optical pattern in which the first metal layer, the second metal layer, and the insulator 230 are complexly patterned, various optical effects may be shown. For example, the patterned first metal layer 233 of FIG. 5A and FIG. 5B, the second metal layer 234 of FIG. 6A and 6B, the pattern of the insulator 230 of FIG. 3A and FIG. 3B may be formed while the first metal layer 233 has an irregular pattern, the second metal layer 234 has a multiple-slit pattern, and the insulator 230 has a mesh pattern.

FIG. 7A to FIG. 7C are diagrams illustrating a manufacturing method of a circular touch panel of FIG. 3 according to an exemplary embodiment.

Referring to FIG. 7A, the insulating substrate 201 is disposed and the first metal layer is deposited on the insulating substrate 201. In this case, the first metal layer may be an opaque metal and may be configured of a single or composite material, such as silver (Ag), copper (Cu), chromium (Cr), aluminum (Al), molybdenum/aluminum/molybdenum (Mo/Al/Mo), or the like.

The first metal layer may be patterned using a first mask so as to form the plurality of connection wirings 260, 261, 262, and 263. In this case, the first metal layer may be patterned at the circular boundary region 210, such that the optical pattern shown in FIG. 5A and

FIG. 5B may be formed, but a repetitive description thereof will be omitted. The plurality of connection wirings 260, 261, 262, and 263 may each have a curved portion and a connecting part connecting the curved portion and a sensing electrode, e.g., the first sensing electrode 240 as shown in FIG. 3A. The curvature of curved portions may be determined based on the curvature of the circular boundary region 210, which may vary depending on the radius of the circular touch panel 200 when the touch panel has a circular shape and the shape of a touch panel (e.g., an elliptical touch panel). For example, the curvature of the curved portions and the curvature of the corresponding peripheral boundary of the touch panel may be substantially the same as shown in FIG. 7A.

Referring to FIG. 7B, the second metal layer is deposited on the plurality of formed connection wirings 260, 261, 262, and 263. The second metal layer may include a transparent electrode such as indium tin oxide (ITO), or the like.

The second metal layer may be patterned, thereby forming the plurality of first sensing electrodes 240 and 241 and the plurality of second sensing electrodes 250 and 251. In this case, the second metal layer may be patterned at the circular boundary region 210, such that the optical pattern shown in FIG. 6A and FIG. 6B may be formed, but a repetitive description thereof will be omitted.

As described above, the plurality of first sensing electrodes 240 and 241 may be integrally formed in the first direction, but the plurality of second sensing electrodes 250 and 251 may be formed in the island-type, or vice versa. As described above, the shape of the sensing electrodes may be modified depending on the product configuration.

Referring to FIG. 7C, after the plurality of first sensing electrodes 240 and 241 and the plurality of second sensing electrodes 250 and 251 are formed, the insulator 230 is stacked. The insulator 230 may be configured to be transparent.

The insulator 230 may be patterned by at least one patterning process and may be patterned to have the via-holes 270 and 271 described above with respect to the bridge electrodes 255. In this case, the insulator 230 may be patterned together with a plurality of opening parts at the outer boundary so as to have the multiple-slit pattern 231 at the circular boundary region 210.

Although not illustrated, a third metal layer is deposited and patterned, thereby forming the bridge electrode 255 connecting two adjacent electrodes of the second sensing electrodes 250 and two adjacent electrodes of the second sensing electrodes 251. Therefore, the circular touch panel 200 shown in FIG. 3A and FIG. 3B may be configured.

Next, other passivation layers and an upper substrate are stacked and encapsulated, such that the circular touch panel 200 may be finished. However, the manufacturing process may be changed depending on a manufacturing product configuration.

In addition, in the case in which the circular touch panel 200 and the circular display panel 400 are integrally formed, the stacked structure and the connection structure may be changed. For example, outer boundary of the circular display panel 400 may have at least one of the above described optical patterns to enhance light diffraction and the like.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A circular touch panel disposed on a circular display panel including a plurality of pixels, the circular touch panel comprising:
a plurality of sensing electrodes;
a plurality of connection wirings connecting the plurality of sensing electrodes to a signal processing circuit; and
an insulator insulating the plurality of sensing electrodes from each other,
wherein the circular touch panel comprises a circular boundary region patterned in an optical pattern.

2. The circular touch panel of claim 1, wherein:
the optical pattern in the circular boundary region comprises a material substantially identical to a material used for forming at least one of the plurality of sensing electrodes, the insulator, and the plurality of connection wirings.

3. The circular touch panel of claim 1, wherein:
the optical pattern comprises at least one pattern of a multiple-slit pattern, a mesh pattern, and an irregular pattern.

4. The circular touch panel of claim 1, wherein:
the optical pattern is configured to exhibit at least one of a light diffraction effect, a light interference effect, and a light scattering effect.

5. The circular touch panel of claim 1, wherein:
the optical pattern is patterned so as to correspond to a non-emitting region in a circular boundary region of the circular display panel; and
the non-emitting region in the circular boundary region of the circular display panel is adjacent to the plurality of pixels having a quadrangular shape.

6. The circular touch panel of claim 1, wherein:
the circular touch panel and the circular display panel are integrally formed.

7. A manufacturing method of a circular touch panel, the manufacturing method comprising:
forming a plurality of connection wirings by depositing and patterning a first metal layer on an insulating substrate;
forming a plurality of sensing electrodes by depositing and patterning a second metal layer such that sensing electrodes disposed adjacent to the plurality of connection wirings are connected to the plurality of connection wirings, respectively; and
forming and patterning an insulator so as to insulate the plurality of sensing electrodes,
wherein when at least one of the plurality of connection wirings, the plurality of sensing electrodes, and the insulator is patterned, an optical pattern is simultaneously patterned on a circular boundary region of the circular touch panel.

8. The manufacturing method of claim 7, wherein:
the optical pattern in the circular boundary region comprises a material identical to a material used for forming at least one of the plurality of connection wirings, the plurality of sensing electrodes, and the insulator.

9. The manufacturing method of claim 7, wherein:
the optical pattern comprises at least one pattern of a multiple-slit pattern, a mesh pattern, and an irregular pattern.

10. The manufacturing method of claim 7, wherein:
the optical pattern is formed to exhibit at least one of a light diffraction effect, a light interference effect, and a light scattering effect.

11. A touch screen panel, comprising:
a substrate comprising a curved boundary region;
a plurality of sensing electrodes disposed on the substrate;
a connection wiring connecting one of the plurality of sensing electrodes to a signal processing circuit; and
an insulator disposed on the plurality of sensing electrodes,
wherein an optical pattern is disposed on the curved boundary region to change a light propagation direction.

12. The touch screen panel of claim 11, further comprising:
a display panel comprising a curved boundary region corresponding to the curved boundary region of the substrate,
wherein the display panel comprises a plurality of pixels to display an image, and
wherein the curved boundary region of the display panel comprises a transparent area through which light passes.

13. The touch screen panel of claim 11, wherein the connection wiring comprises a curved portion, and
wherein a curvature of the curved portion corresponds to a curvature of the curved boundary region.

14. The touch screen panel of claim 11, wherein the insulator comprises a slit or a recess to form the optical pattern.

15. The touch screen panel of claim 11, further comprising:
a metal pattern disposed on the curved boundary region of the substrate to form the optical pattern.
